(19) United States
(12) Patent Application Publication
(10) Pub. No.: US 2010/0114993 A1
(43) Pub. Date: May 6, 2010

(54) Data Transformation System and Method

(76) Inventors: Jean M. Holschbach, St. Paul, MN (US); Kevin M. Johnson, St. Paul, MN (US); Miles R. Porter, Plymouth, MN (US); Karl W. Knoblauch, Bloomington, MN (US); Sunil S. Bhujle, Eden Prairie, MN (US)

Correspondence Address: MEDTRONIC, INC., 710 MEDTRONIC PARKWAY NE, MINNEAPOLIS, MN, 55432-9924, US

(21) Appl. No.: 12/263,410

(22) Filed: Oct. 31, 2008

(51) Int. Cl. G06F 17/30

(52) U.S. Cl. 707/810; 707/E17.044

(57) ABSTRACT

A data transformation system and method for importing data from an implantable medical device from a particular manufacturer is provided. The data transformation system includes a data transformation engine. The data transformation engine includes a bootstrap subsystem that receives the data in a native format and determines the particular manufacturer. The data transformation engine also includes a data transformation component that categorizes at least some of the data into an object model representation and a data normalization component that normalizes at least some of the data in the object model representation and serializes the object model representation into an extensible markup language file. The data transformation engine further includes a schema transformer that validates the extensible markup language file.

### TECHNICAL FIELD

The present invention relates generally to a system and method for importing information from an implantable medical device.

### BACKGROUND

Implantable medical device systems generally include an implantable medical device (such as a pacemaker or a defibrillator), pacing and/or sensing leads, and a programmer. The leads connect the implantable medical device to the heart of a patient. The implantable medical device stores different types of diagnostic data which assist a clinician in evaluating both the patient's heart and the operation of the device. The specific diagnostic data stored in the device includes a variety of information, such as a real-time recording of pacing events.

The programmer of the implantable medical device system performs several functions including (a) assessing lead performance during a pacemaker or defibrillator implantation, (b) programming the implantable medical device, and (c) receiving feedback from the implantable medical device for use by the clinician.

Systems have been developed to view and store information relating to the implantable medical device and the patient at a remote location. For example, systems have been developed to transfer specific information about the implantable medical device to a remote location so that the information can be stored within a database or included within a report. However, some conventional systems retrieve information from an implantable medical device either in a “memory dump” formation which mirrors the manufacturer's format for the device and basically “dumps” the information from the implantable medical device to the programmer. Other conventional systems retrieve information from an implantable medical device in a specific format, such as an America Standard Code for Information Interchange (ASCII) format, a waveform format, a numeric format, or a binary format. Information in any of these formats cannot easily be transferred via the Internet and converted into coherent information due to formatting issues. Thus, it is extremely difficult to interpret information in any of these formats in order to properly store the information at a remote location or generate a report based upon the information.

Additionally, systems have been developed to perform testing on information from implantable medical devices. As implantable medical devices from different manufacturers generate information in different formats, it is difficult to perform automated testing across a varied patient population. Until a standard for communication of implantable medical device data is implemented, information generated by different manufacturers' implantable medical devices needs to be interpreted properly and transformed into a common format for automated testing to be possible.

### SUMMARY

In one or more embodiments, a data transformation engine for obtaining data in a native format from a programmer of an implantable medical device from a particular manufacturer is provided. The data transformation engine includes a bootstrap subsystem that receives the data in the native format from the programmer and determines the particular manufacturer. The data transformation engine also includes a data transformation component that categorizes at least some of the data into an object model representation and a data normalization component that normalizes at least some of the data in the object model representation and serializes the object model representation into an extensible markup language file. The data transformation engine further includes a schema transformer that validates the extensible markup language file.

In one or more embodiments, a method of transforming data from an implantable medical device having a native format for a particular manufacturer is provided. The method includes receiving the data in the native format and determining the particular manufacturer. The method also includes categorizing at least some of the data into an object model representation and normalizing at least some of the data in the object model representation. The method further includes serializing the object model representation into an extensible markup language file.

### DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a schematic diagram of an implantable medical device (IMD) in accordance with an embodiment of the present disclosure.

FIG. 2 is a data transformation system in accordance with an embodiment of the present disclosure for use in communication with the IMD of FIG. 1 and a programmer.

FIG. 3 is a flow chart illustrating the operation of a data transformation engine for use with the data transformation system of FIG. 2.

FIGS. 4A-4I are object model representations created by the data transformation engine of FIG. 3.

### DETAILED DESCRIPTION

The present disclosure describes a system which permits specific desired information to be transferred to a location remote from an implantable medical device in a format that can easily be interpreted and manipulated. The system can allow for interpretation of data from the implantable medical device such that the information can be stored within a database, a report can be generated based upon the transferred information, and automated testing can be performed on the information regardless of the manufacturer of implantable medical device.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings, whether mechanical or electrical. Further, “connected” and “coupled” are not restricted to physical, mechanical, or electrical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

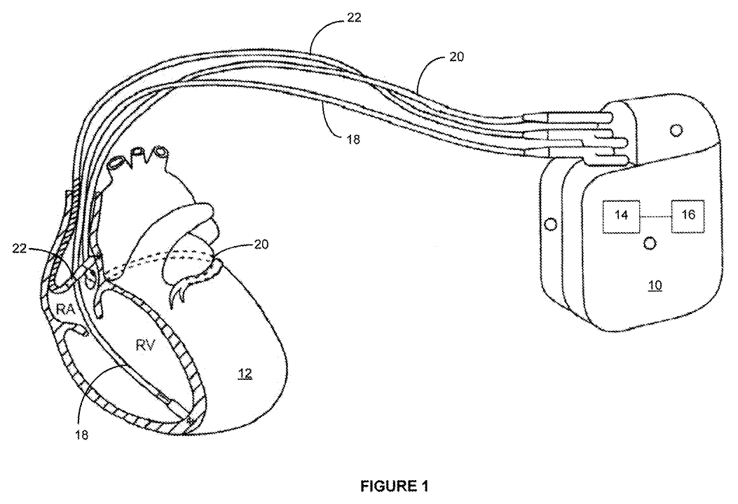

FIG. 1 is an illustration of an exemplary implantable medical device (“IMD”) 10 connected to monitor a patient's heart 12. The IMD 10 can be configured to integrate both monitoring and therapy features. The IMD 10 can collect and process data about the heart 12 from one or more sensors and an electrode pair for sensing, e.g., cardiac electrogram (EGM) signals. As shown in FIG. 1, the IMD 10 can be generally flat and thin to permit subcutaneous implantation within a human body, e.g., within upper thoracic regions or the low abdominal region. The IMD 10 can be provided with a hermetically-sealed housing that encloses a processor 14, a digital memory 16, and other components as appropriate to produce the desired functionalities of the IMD 10. In various embodiments, the IMD 10 is implemented as any implanted medical device capable of measuring the heart rate of a patient and other signals, including, but not limited to a pacemaker, defibrillator, electrocardiogram monitor, blood pressure monitor, drug pump, insulin monitor, or neurostimulator. Examples of the IMD 10 include implantable cardiac pacemakers disclosed in U.S. Pat. No. 5,158,078 to Bennett et al., U.S. Pat. No. 5,312,453 to Shelton et al., or U.S. Pat. No. 5,144,949 to Olson, all hereby incorporated by reference herein, each in its respective entirety.

The processor 14 can be implemented with any type of microprocessor, digital signal processor, application specific integrated circuit (ASIC), field programmable gate array (FPGA) or other integrated or discrete logic circuitry programmed or otherwise configured to provide functionality as described herein. The processor 14 executes instructions stored in digital memory 16 to provide functionality to the IMD 10. Instructions provided to the processor 14 can be executed in any manner, using any data structures, architecture, programming language and/or other techniques. The digital memory 16 can be any storage medium capable of maintaining digital data and instructions provided to processor 14 such as a static or dynamic random access memory (RAM), or any other electronic, magnetic, optical or other storage medium.

As further shown in FIG. 1, the IMD 10 can receive one or more cardiac leads for connection to circuitry enclosed within the housing. In the example of FIG. 1, the IMD 10 receives a right ventricular endocardial lead 18, a left ventricular coronary sinus lead 20, and a right atrial endocardial lead 22, although the particular cardiac leads used will vary from embodiment to embodiment. In addition, the housing of the IMD 10 may function as an electrode, along with other electrodes that may be provided at various locations on the housing of the IMD 10. In alternate embodiments, other data inputs, leads, electrodes and the like may be provided.

The IMD 10 suitably collects and processes data about the heart 12 from one or more sources (e.g., heart rate monitor, blood pressure monitor etc.). The IMD 10 can also obtain input data from other internal or external sources such as an oxygen sensor, pH monitor, accelerometer or the like.

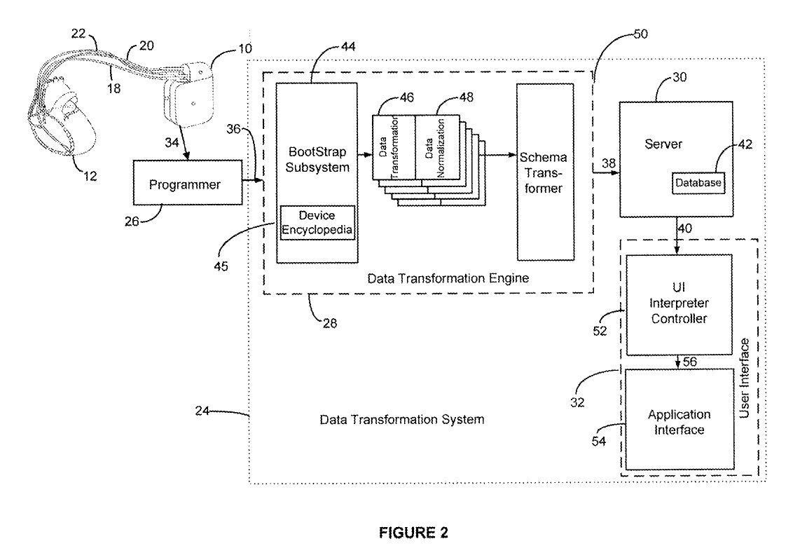

FIG. 2 illustrates the IMD 10, a data transformation system 24, and a programmer 26 according to one embodiment of the present disclosure. The data transformation system 24 can include a transformation engine 28, a server 30, and a user interface 32. A connection 34 can provide radio frequency communication between the IMD 10 and the programmer 26. A clinician can establish a communication link via the connection 34 to retrieve information stored within the IMD 10. A connection 36 can interconnect the programmer 26 to the transformation engine 28. The connection 36 can be any suitable connection that will facilitate the transfer of information between the programmer 26 and the transformation engine 28. The transformation engine 28 can be installed in a personal computer in a clinician's office or clinic. A connection 38 can connect the transformation engine 28 to the server 30. A connection 40 can connect the server 30 to the user interface 32. The connections 38 and 40 can be an internet connection, such as a local area network (LAN) connection, a telephone line connection, a radio frequency connection, etc. The programmer 26, the transformation engine 28, the server 30, and the user interface 32 can be in a single or multiple computers and servers. The server 30 can include a database 42. The data transformation system 24 can be used in conjunction with an existing clinic management system.

Regardless of the manufacturer of the IMD 10, the information stored within the IMD 10 can be transmitted to the programmer 26 via the connection 34 in an initial procedure which transfers the information from the IMD 10 to the programmer 26 without changing the format of the information. Examples of formats include waveform encoding formats, numeric formats, binary formats, and ASCII format. The programmer 26 can create data streams of information from the IMD 10. The programmer 26 can be specific to the IMD 10 manufacturer and the data streams created can have attributes specific to the manufacturer. The data streams can be transmitted from the programmer 26 to the transformation engine 28 via the connection 36. In some embodiments, the data streams can be transmitted from the programmer 26 to an intermediate disk and can then be transmitted to the transformation engine 28. The transformation engine 28 can analyze the data stream to determine the specific IMD manufacturer and can use a transformation mechanism specific to that manufacturer to extract and categorize desired information. The transformation engine 28 can normalize the information and format the information into a standard extensible markup language (XML) schema to create an XML file. The XML file can be transmitted to the server 30 for analysis and/or storage in the database 42 via the connection 38. In some embodiments, the database 42 can store patient medical records, and the XML file from a patient's IMD 10 can be stored with that patient's medical record. The XML file can be further transmitted from the server 30 to the user interface 32 via the connection 40.

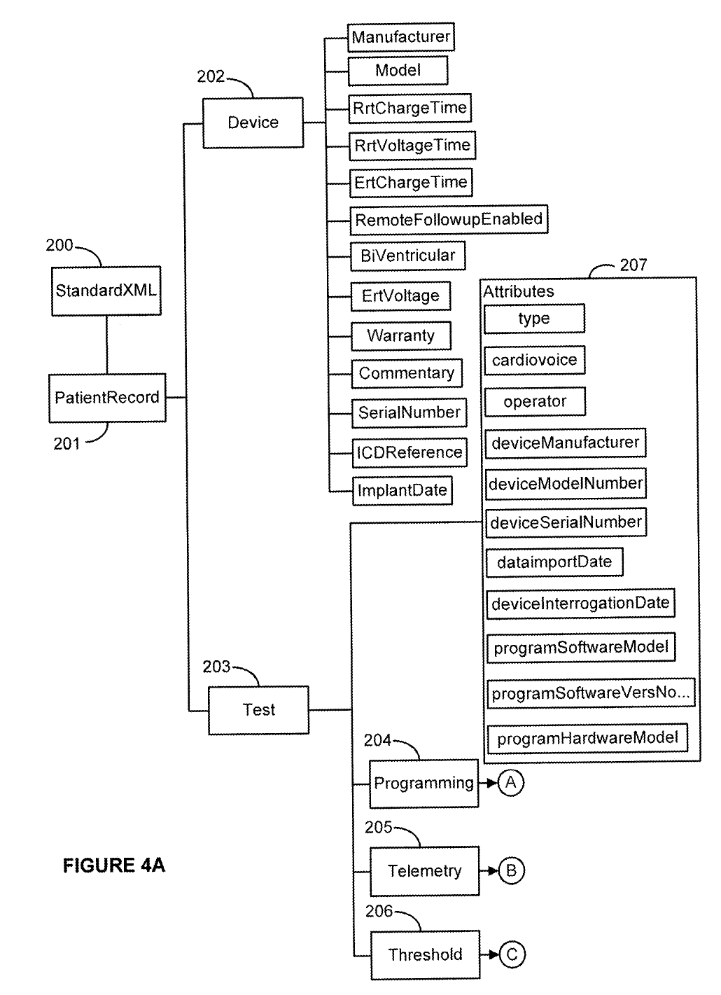

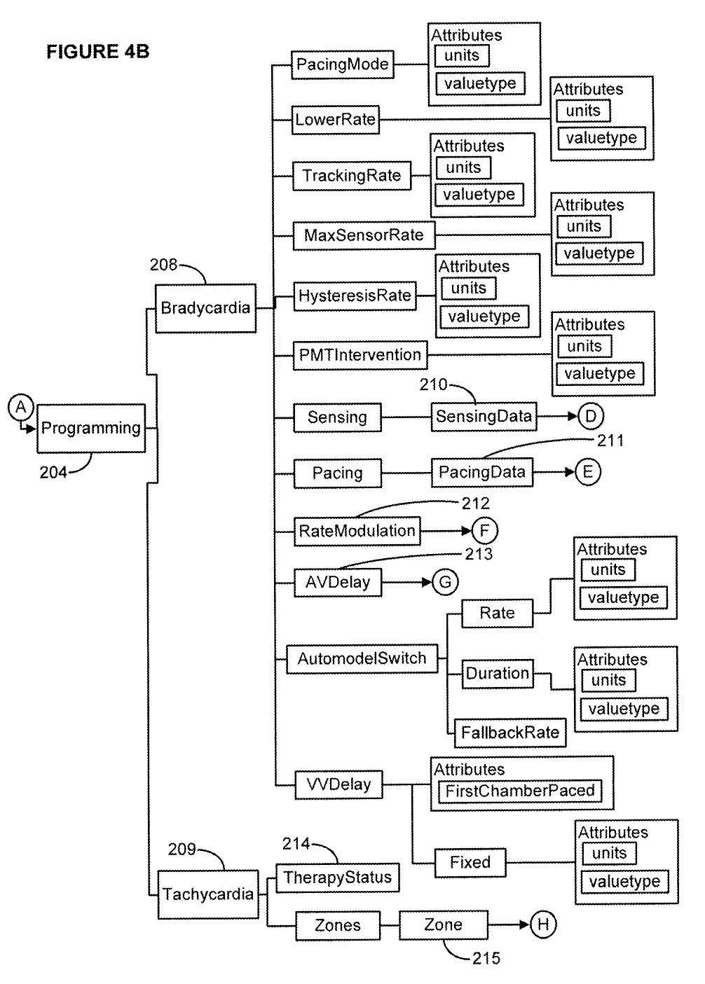

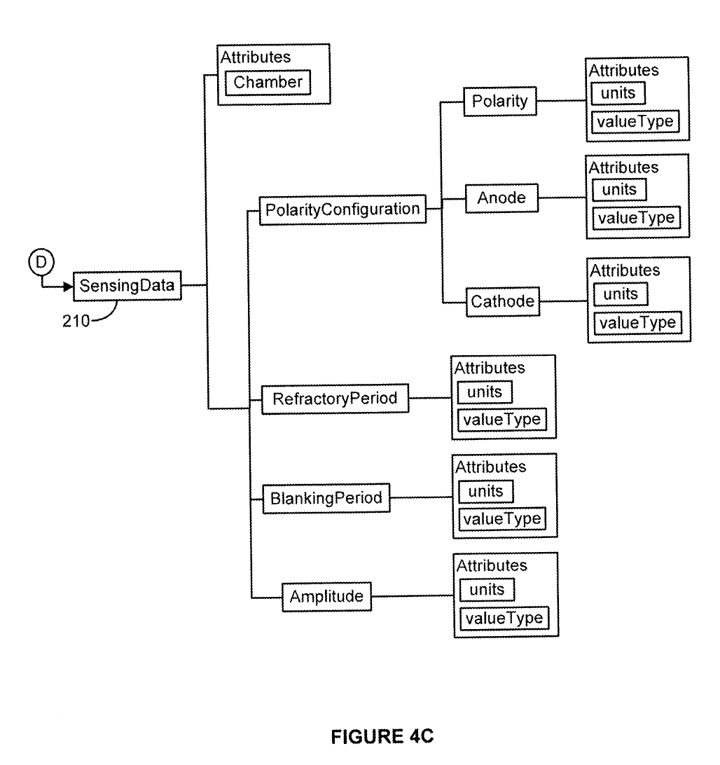

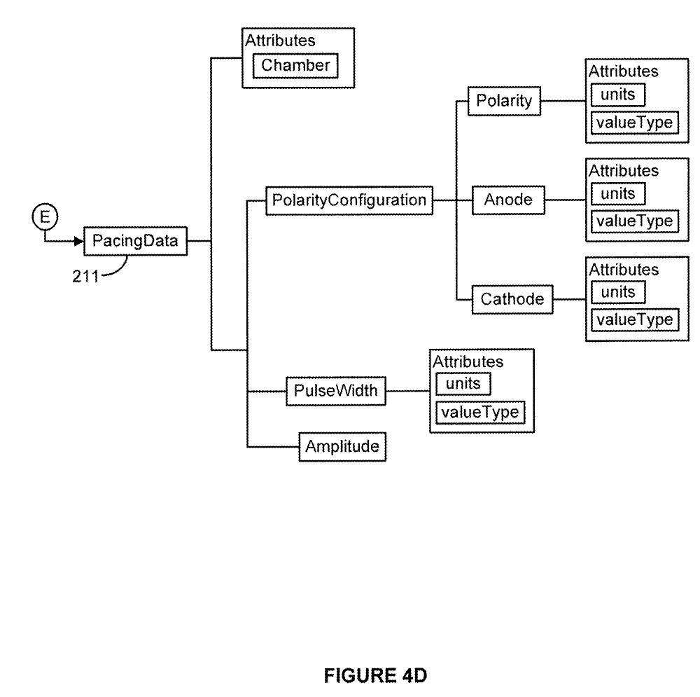

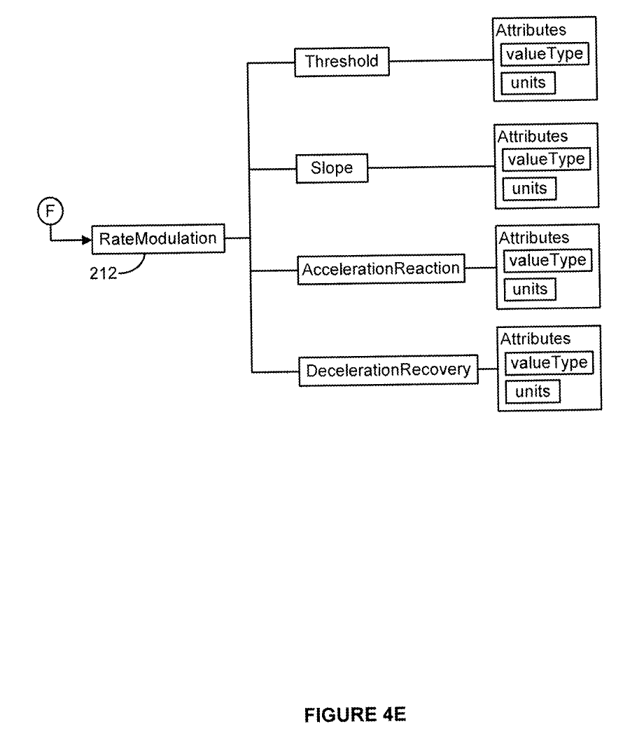

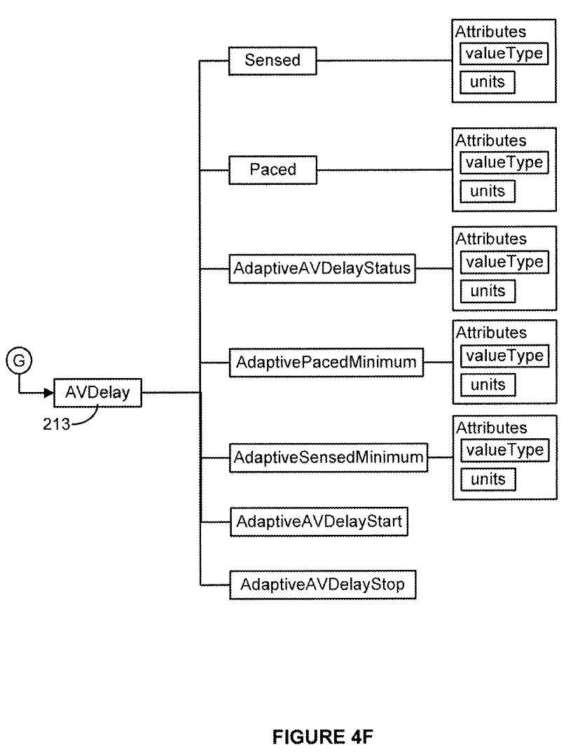

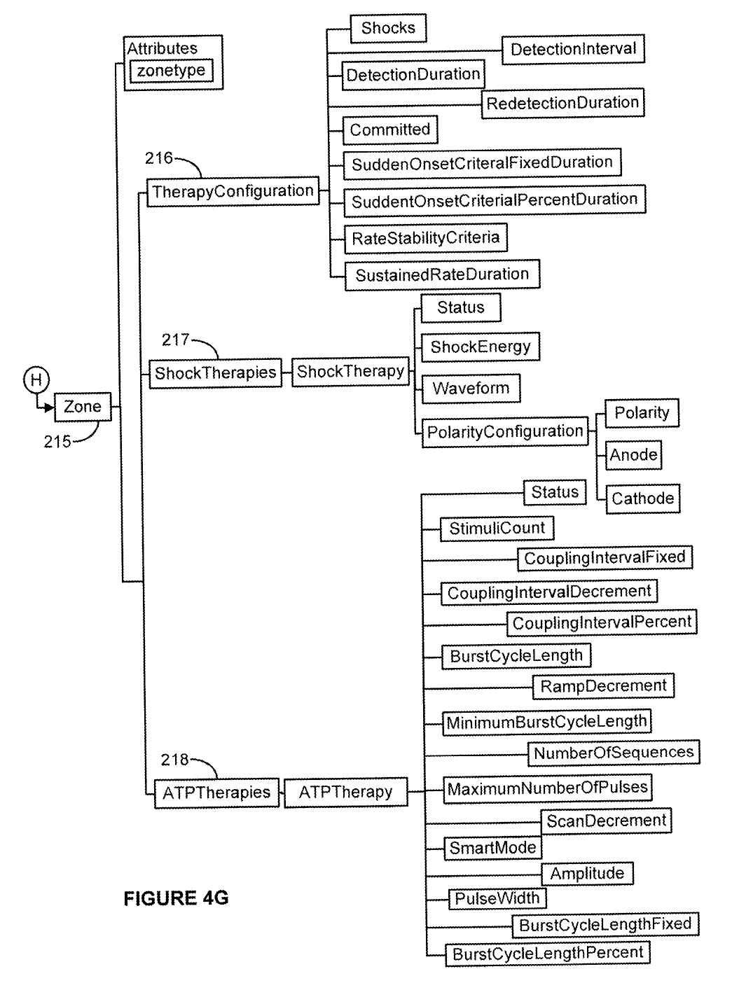

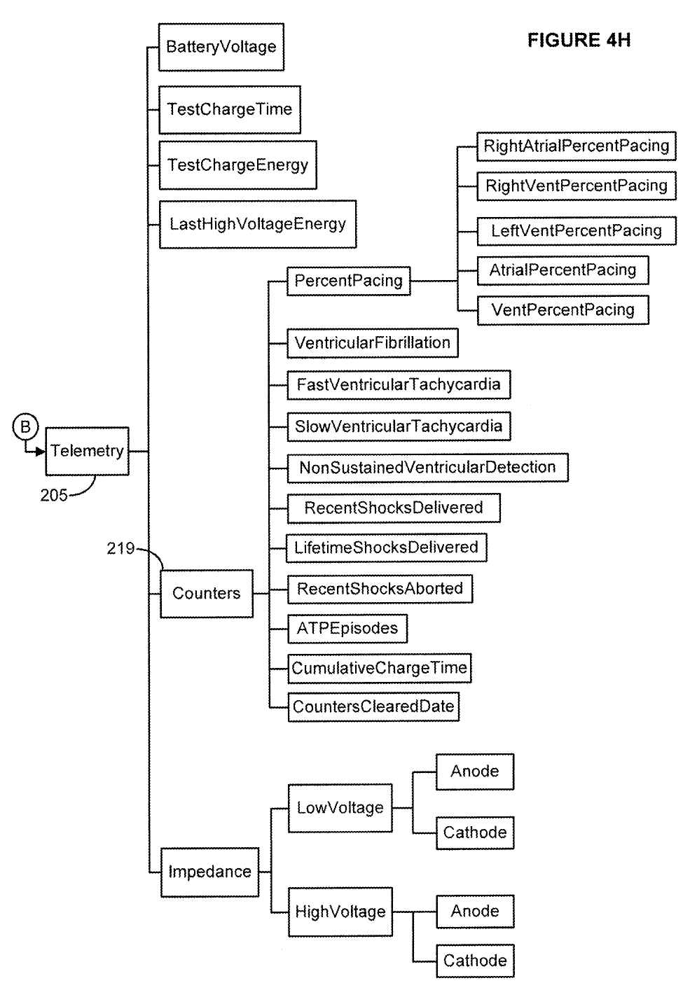

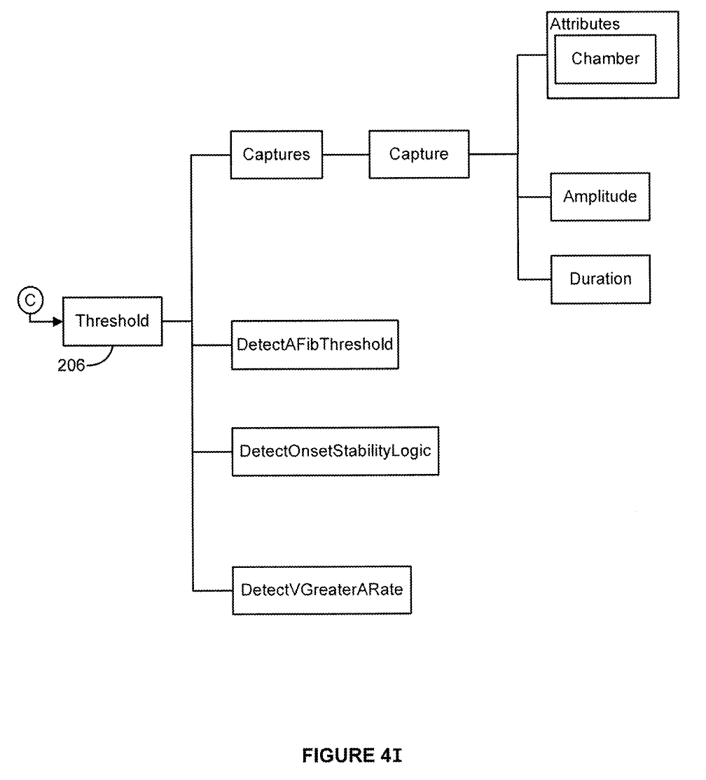

As also shown in FIG. 2, the transformation engine 28 can include a bootstrap subsystem 44, several data transformation components 46 for different manufacturers, several data normalization components 48 for different manufacturers, and a schema transformer 50. Data can first be transmitted from the programmer 26 to the bootstrap subsystem 44. At this point, the data can be in its native format according to the device manufacturer. The bootstrap subsystem 44 can analyze the data, determine the device manufacturer, and select the appropriate components (i.e., a particular data transformation component 46 and a particular data normalization component 48 specific to that device manufacturer) to which the data will be transferred. The data can be transferred in its native format to the particular data transformation component 46. The particular data transformation component 46 can categorize the data into a standardized object model representation (as shown and described with respect to FIGS. 4A-4I). The particular data normalization component 48 can scale or normalize values of the data categorized in the standard object model and serialize the data into an XML format. The data can be forwarded in XML format to the schema transformer 50. The schema transformer 50 can verify the data from the incoming XML format to produce a final XML file. The schema transformer 50 can also modify the incoming XML format to produce the final XML file in relation to a particular software application or version used by the user interface 32. From the schema transformer 50, the final XML file can be transmitted to the server 30.

To differentiate between device manufacturers, the bootstrap subsystem 44 can include a device encyclopedia 45. The device encyclopedia 45 can include information regarding data attributes of various devices and their respective manufacturers. The device encyclopedia 45 can be updated to include new devices as they become available.

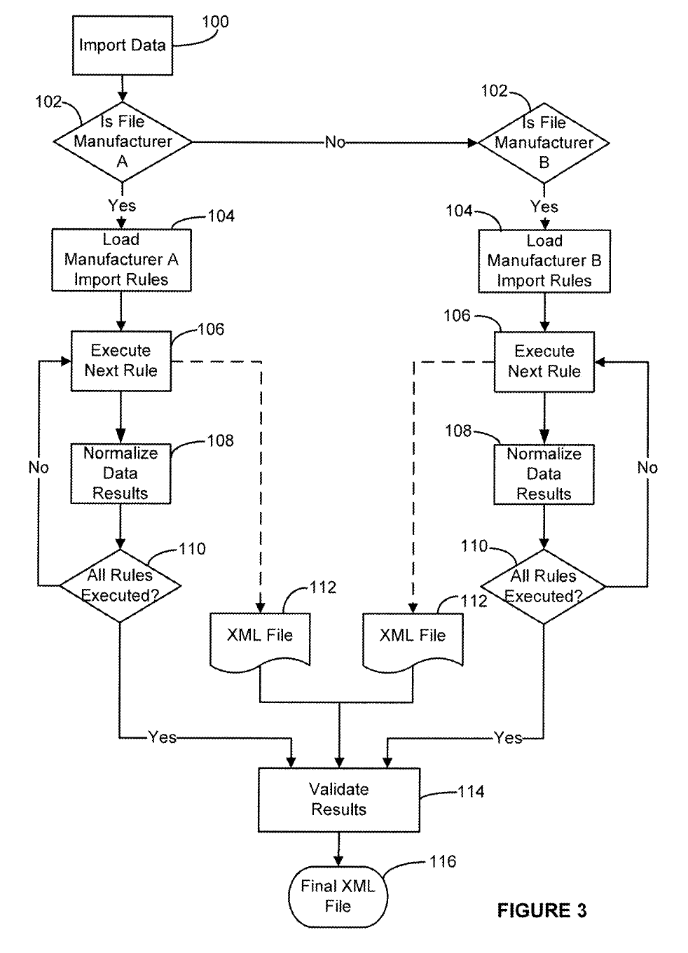

FIG. 3 illustrates the operation of the transformation engine 28, according to one embodiment of the present disclosure. The data is imported (task 100) to the data transformation engine 28. In some embodiments, the data can be a file or a stream of binary data. The bootstrap subsystem 44 determines the manufacturer of the IMD 10 (task 102). The bootstrap subsystem 44 checks through the device encyclopedia 45 until the manufacturer is determined (task 102). The process then continues down a path for Manufacturer A or Manufacturer B, for example. Once the manufacturer has been determined, a set of import rules specific to the manufacturer are loaded into the particular data transformation component 46 (task 104). Each rule is executed (task 106) to locate particular portions of the data and categorize them into the object model representation. The categorized data is normalized as needed (task 108) by the particular data normalization component 48. For example, some IMDs can record data per minute, while others can record data per second. In this case, the data can be normalized to a standard unit (e.g., all data normalized to “per second” units). A loop continues the transformation and normalization process until all the rules are executed (task 110). As all of the rules are executed, the transformed and normalized data is exported and formatted into an XML file (task 112). Once all of the rules have been executed, the XML file (generated at task 112), is verified and validated by a set of manufacturer neutral rules (e.g., formatting and relevancy rules) by the schema transformer 50 (task 114). Once the XML file has been verified and validated, the final XML file is ready to be transmitted to the server 30 (task 116).

FIGS. 4A-4I illustrate the object model representation of data created by the data transformation component 46 according to one embodiment of the present disclosure. The parameters of the object model representation can vary and more or less parameters can be used. Using the transformation component 46 to create the object model representation in a standard XML format allows the data to be more easily interpreted. Additionally, the object model representation created in a standard XML format can make it easier to use parameters to find relationships of data, for example, with automated testing.

FIG. 4A illustrates the standard XML title block 200 leading to a patient record block 201. The patient record block 201 can include two categories: a device block 202 and a test block 203. Static information about the IMD 10 can be saved under the device block 202, such as the manufacturer, the model, the recommended replacement time (RRT), the elective replacement time (ERT), the warranty, any commentary associated with the device, the serial number, reference to an implantable cardioverter defibrillator (ICD), and the implant date. The test block 203 can include dynamic information about the device, such as a programming block 204, a telemetry block 205, a threshold block 206, and an attributes block 207. The attributes block 207 can include information related to the data import process (such as the data type, the operator, and the import date), information related to the device (such as the manufacturer, the model number, the serial number, and the interrogation date), and information related to the programmer (such as the programmer software model, the programmer software version number, and the programmer hardware model).

FIG. 4B illustrates the programming block 204, which can further be categorized into a bradycardia block 208 and a tachycardia block 209. The bradycardia block 208 can store data parameters in categories such as pacing mode, lower rate, tracking rate, max sensor rate, hysteresis rate, PMT intervention, automatic model switch, and VV delay. The parameters can be stored as particular values and their units. The bradycardia block 208 can include categories that are further sorted, such as a sensing data block 210, a pacing data block 211, a rate modulation block 212, and an AV delay block 213. The tachycardia block 209 can include a therapy status block 214 that includes information about the status of therapies administered and a zone block 215. The zone block 215 can be further categorized to include therapy information data.

FIG. 4C illustrates the sensing data block 210. The sensing data block 210 can store data parameters relating to sensing (such as sensing attributes, refractory periods, blanking periods, and amplitudes). The sensing data block 210 can also store polarity configuration parameters including information about the polarity designation, the anode, and the cathode. The parameters can be stored as particular values and their units.

FIG. 4D illustrates the pacing data block 211. The pacing data block 211 can store data parameters relating to pacing such as pacing attributes as well as pulse width and amplitude. The pacing data block 211 can also store polarity configuration parameters including information about the polarity designation, the anode, and the cathode. The parameters can be stored as particular values and their units.

FIG. 4E illustrates the rate modulation block 212. The rate modulation block 212 can store parameters relating to heart rate modulation such as thresholds, slopes, acceleration reactions, and deceleration recovery. The parameters can be stored as particular values and their units.

FIG. 4F illustrates the AV delay block 213. The AV delay block 213 can store parameters relating to AV delay of the heart 12 such as sensing, pacing, adaptive AV delay status, adaptive paced minimums, adaptive sensed minimums, adaptive AV delay start time and adaptive AV delay stop time. The parameters can be stored as particular values and their units.

FIG. 4G illustrates the zone block 215. The zone block 215 can store parameters relating to therapies such as therapy configurations (block 216), shock therapies (block 217), and ATP therapies (block 218). The therapy configuration block 216 can store configuration parameters relating to therapies administered, such as a shocks, detection interval, detection duration, redetection duration, committed therapies, fixed and percent durations for sudden onset criteria, rates for stability criteria, and sustained rate durations. The shock therapies block 217 can store parameters relating to shock therapies, such as status, shock energy, waveforms, and polarity configurations of leads. The ATP therapies block 218 can store parameters relating to ATP therapies such as status, stimuli count, coupling interval information, burst cycle information, pulse information, etc.

FIG. 4H illustrates the telemetry block 205. The telemetry block 205 can store dynamic parameters relating to the device, such as battery voltage, test charge time, test charge energy, last high voltage energy, event counters (block 219), and impedance of leads. Events that can be counted and stored under the event counters block 219 can include ventricular fibrillation, fast ventricular tachycardia, slow ventricular tachycardia, non-sustained ventricular detection, recent shocks delivered, lifetime shocks delivered, recent shocks aborted, ATP episodes, percent pacing of atria and ventricles, and cumulative charge time. The events counter block 219 can also store the last date that all counters were cleared.

FIG. 4I illustrates the threshold block 206. The threshold block 206 can store parameters relating to detectable thresholds, such as amplitude and duration of events stored (captured), the atrial fibrillation threshold, onset stability logic detection parameters, and atrial to ventricular comparison rates.

As shown in FIG. 2, the user interface 32 can include a user interface (UI) interpreter controller 52 and an application interface 54. The UI interpreter controller 52 can receive a signal when a specific patient's data has been entered into the database 42. The UI interpreter controller 52 can also forward the data to the application interface 54 and to other interface components. The application interface 54 can display the standard, normalized device data to the clinician. Using the standard object model representation in the XML format to create more organized patient data can permit clinicians to easily retrieve various desired parameters with the application interface 54.

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A data transformation engine for obtaining data in a native format from a programmer of an implantable medical device from a particular manufacturer of a plurality of manufacturers, the data transformation engine comprising:
a bootstrap subsystem that receives the data in the native format from the programmer and determines the particular manufacturer;
a data transformation component that categorizes at least some of the data into an object model representation;
a data normalization component that normalizes at least some of the data in the object model representation and serializes the object model representation into an extensible markup language file; and
a schema transformer that validates the extensible markup language file.

2. The data transformation engine of claim 1 wherein the bootstrap subsystem includes a device encyclopedia with detectable attributes about the native format of the particular manufacturer.

3. The data transformation engine of claim 1 wherein the data transformation component determines the at least some of the data to categorize based on the particular manufacturer determined by the bootstrap subsystem.

4. The data transformation engine of claim 1 wherein the data normalization component normalizes the at least some of the data based on the particular manufacturer determined by the bootstrap subsystem.

5. The data transformation engine of claim 1 wherein the at least some of the data includes at least one of static information about the implantable medical device and dynamic information about the implantable medical device.

6. The data transformation engine of claim 5 wherein the static information about the implantable medical device includes at least one of the particular manufacturer, model information, recommended replacement time information, elective replacement time information, warranty information, commentary, serial number information, references, and implant date information.

7. The data transformation engine of claim 5 wherein the dynamic information of the implantable medical device includes at least one of programming information, telemetry information, threshold information, process-related attributes, device-related attributes, and programmer-related attributes.

8. The data transformation engine of claim 7 wherein the programming information includes at least one of pacing mode information, lower rate information, tracking rate information, max sensor rate information, hysteresis rate information, PMT intervention information, automatic model switch information, VV delay information, sensing information, pacing information, rate modulation information, AV delay information, and therapy status information.

9. The data transformation engine of claim 7 wherein the telemetry information includes at least one of battery voltage information, test charge time information, test charge energy information, last high voltage energy information, event counters, and impedance information.

10. The data transformation engine of claim 7 wherein the threshold information includes at least one of amplitude and duration of events stored, atrial fibrillation threshold information, onset stability logic detection parameters, and atrial to ventricular comparison rates.

11. The data transformation engine of claim 7 wherein the process-related attributes include at least one of data type information, operator information, and import date information.

12. The data transformation engine of claim 7 wherein the device-related attributes include at least one of manufacturer attributes, model number information, serial number information, and interrogation date information.

13. The data transformation engine of claim 7 wherein the programmer-related attributes include at least one of programmer software model information, programmer software version information, and programmer hardware model information.

14. The data transformation engine of claim 8 wherein the therapy status information includes at least one of therapy type information, therapy configurations information, shock therapies information, and ATP therapies information.

15. The data transformation engine of claim 1 wherein the extensible markup language file is used for automated testing.

16. A method of transforming data from an implantable medical device having a native format for a particular manufacturer of a plurality of manufacturers, the method comprising:
receiving the data in the native format;
determining the particular manufacturer;
categorizing at least some of the data into an object model representation;
normalizing at least some of the data in the object model representation; and
serializing the object model representation into an extensible markup language file.

17. The method of claim 16 and further comprising validating the extensible markup language file.

18. The method of claim 16 and further comprising providing a server and transmitting the extensible markup language file to the server.

19. The method of claim 16 and further comprising providing a user interface and transmitting the extensible markup language file to the user interface.

20. The method of claim 19 and further comprising modifying the extensible markup language file in relation to a particular software application used by the user interface.
